(19) United States
(12) Patent Application Publication
(10) Pub. No.: US 2005/0041647 A1
(43) Pub. Date: Feb. 24, 2005

(54) Internet voice & data messaging (IVDM) portal

(76) Inventor: Desmond L. Stinnie, Baltimore, MD (US)

Correspondence Address: Royal W. Craig;Law Offices of Royal W. Craig, Suite 153, 10 N. Calvert Street, Baltimore, MD, 21202, US

(21) Appl. No.: 10/902,751

(22) Filed: Jul. 29, 2004

Related U.S. Application Data
(60) Provisional application No. 60/492,285, filed on Aug. 5, 2003.

(51) Int. Cl. H04L 12/66

(52) U.S. Cl. 370/352

(57) ABSTRACT

An online voice messaging service that integrates all tools needed for an advertising sales representative to resell to their customers, in real time, a blind “ad box” including a temporary anonymous toll-free phone number with attached Internet Voice & Data Messaging (IVDM) service for collecting ad responses, such that the toll-free phone number can be incorporated into the text of the customer's advertisement as it is being booked. The software includes a portal or web interface that facilitates reselling of the service via a channel of resellers, such as media companies with sales representatives that have a service agreement with the service. The software also includes a separate portal for direct sales. Various value-added, user-options are provided including notifications of new messages, the ability to receive rental and/or credit applications, payments from customers, management of multiple ad boxes with one logon, and to retrieve messages as .wav files, emails as .txt files, and faxes as .pdf (or similar) files.

### CROSS-REFERENCE TO RELATED APPLICATION(S)

The present application derives priority from U.S. provisional application Ser. No. 60/492,285 filed Aug. 5, 2003.

### BACKGROUND OF THE INVENTION

1. Field of the Invention

The present invention relates to voice & data messaging systems and, more specifically, to an Internet Voice & Data Messaging (IVDM) system with message broadcasting specifically designed to allow advertisers to outsource their messaging responsibilities.

2. Description of the Background

Most existing voice & data messaging solutions are straightforward telephone answering systems that are built into a phone system. For example, Advanced Call Center® from Pingram Marketing is answering machine software installed on a dedicated computer that provides a simple-to-use answering machine with Caller ID for your voice modem. Advanced call forwarding features include pager notification, sending call details and voice messages over email, and starting an external fax program when an incoming fax call is recognized. While these are helpful features, their utility is limited to the home user or small business owner who wants a computer voice messaging solution attached to an existing phone line.

Many business organizations have greater needs, and have expanded their former phone-based call centers into comprehensive internet-based customer interaction centers, employing technologies such as email response management systems, online chat and Web page pushing/co-browsing. However, web-enabled systems require the right hardware, software (including licenses) and bandwidth. Dedicated servers are required to support the software that allows for integrated Web services. These servers can cost anywhere from $25,000 to $50,000 or more, depending on the number of workstations and system requirements. For many potential customers that have not yet implemented any Web-enabled communication, the hardware, software and licensing requirements to construct a web-enabled call center may be cost-prohibitive.

Under the foregoing circumstances it can make sense to outsource to an application service provider (ASP). An ASP owns all of the software and hardware and, in essence, rents it to companies and/or individuals who choose not to invest in their own. Users are able to access the programs using the Internet, IP phones, and/or any standard PSTN (Public Switched Telephone Network) telephony devices. There are two types of existing Web-based ASP call centers. Americall®, an example of one, caters to the business organizations with greater needs for comprehensive internet-based customer interaction centers. Americall(®) offers ASP inbound call center services, outbound call center services, order taking, customer service, class and seminar registration, answering services and web enabled customer support. They Support literature fulfillment, inventory control, credit card transaction processing, order tracking, shipping, and taxing, as well as “up-sell and cross-sell” of products and services.

For customers with small-scale needs there are a number of Internet-based ASP voice messaging call centers, such as Onebox.com and uReach.com. With these, an individual can get voicemail, email and fax-using an assigned phone number. Anyone can check email, voice mail and faxes from the Web, telephone or wireless devices, and can listen to voice mail and email over the phone. They can even respond to email by recording a voice response and sending it by computer. These services work on your existing phone line, and essentially pick the line after a set number of rings.

There is a rather specific need for an ASP-based Internet Voice & Data Messaging provider to the advertising community. Individual advertisers want anonymity. For example, if Mr. Smith is selling a tractor and decides to place a classified advertisement, he also wants a secure and discrete service for interacting with callers. He would prefer not to give out his personal phone number in the advertisement, but would rather have a specially-assigned temporary toll-free phone number for the duration of the ad. In as much as the individual advertiser's need is apparent, the sponsoring advertisement seller can also benefit by offering such a service to all of their customers, by making classified advertising more palatable to security-conscious individuals, as well as having responses tracked. Advertisement sellers offer value-added features such as attention banners, bold print, color fonts, etc. They have, however, no way of determining whether these products increase the effectiveness of the ad, or yield better results (responses) for their advertisers. Commercial advertisers (those offering employment, home rentals & sales, automobile sales, etc.) desire to know which ad is giving them the most benefit for their dollar. For example, a homeowner selling a house may place an ad in three different publications. With all of the calls coming to their home number, they are unable to easily determine which ad yielded the call. Utilizing an ASP that provides a message box for each ad would immediately reveal which publication is yielding the responses. An ASP-based Internet Voice & Data Messaging service that newspapers can provide to their advertising community would provide them with a significant competitive edge. There is a real commercial need for an ASP-based Internet messaging service that newspapers can offer and seamlessly resell to their classified advertisers, all at the same time that the ad space is being booked.

### SUMMARY OF THE INVENTION

It is therefore an objective of the present invention to provide an ASP framework for Internet Voice & Data Messaging services (inclusive of the Application Service Provider architecture, a secure server facility, and a comprehensive voice & data messaging solution with a subscriber interface) to allow media companies such as newspapers, the ability to offer and seamlessly resell to their advertisers, an anonymous Internet Voice & Data Messaging “AdBox” at the same time as that ad space is being booked.

It is another objective to provide individual advertisers with a comprehensive, web-enabled voice & data messaging solution, by which they can purchase temporary “AdBoxes” for their advertisements with specially-assigned “AdBox” numbers for ad response.

It is still another objective to allow media companies to simplify and streamline the 3 steps of subscribing, tracking responses, and analyzing their classified advertising customers.

In accordance with the foregoing objectives, the present invention is an ASP topology for online voice & data messaging services designed to integrate all the tools needed for an advertising sales representative to resell to their customers, in real time, a blind “AdBox” including a temporary, anonymous toll-free phone number with attached Internet Voice & Data Messaging (IVDM) service for collecting ad responses, such that the toll-free phone number can be incorporated into the text of the advertisement as it is being booked. The architecture includes a secure, web-enabled server facility with resident software. The method of the present invention is embedded in the software, which is resident on the web server. The method provides owners of classified advertisements a secure and discrete location to interact with potential consumers of their products, and also allows advertising sales representatives to resell this “AdBox” service to the advertiser while on the phone-line placing the ad. Each AdBox includes a toll-free phone number to receive calls and faxes from potential buyers of their product, a voice & data message box, an email address that is integrated with the “AdBox” number (AdBox number@myadbox.com or similar domain name), plus various value-added features including but not limited to notifications of new messages, the ability to receive rental and/or credit applications, resumes, various methods of receiving payment from customers, the ability to manage multiple AdBoxes with a single logon in one unified inbox environment (as shown in FIG. 18), the ability to hold voice messages as .wav files, emails as .txt files, and faxes as .pdf, .tiff, or similar type files.

The software includes a portal or web interface that facilitates reselling of the service to advertisers via a channel of resellers, such as media companies with sales representatives that have a service agreement with the ASP. Each reseller is given a unique reseller ID, and each agent of the reseller has a unique ID within the reseller's organization. If an advertiser agrees to purchase the service, the reseller agent may log in to the web portal (provided by the ASP which resides on the reseller's network), in real time (while still on the phone with the advertiser), and populate a form to provide the specific information needed to setup the “AdBox”. When the form is complete, the agent will submit the form over the web. The present software evaluates the elements of the form, and subsequently assigns an “AdBox” number and a local access phone number for the advertiser to retrieve messages (and setup the “AdBox”), after which a confirmation is relayed back to the agent for communication to the advertiser in real time. Upon receipt of the information, the advertiser may log in to their message box to set preferences and a personal greeting. By telephone, the advertiser can dial the local access phone number, and enter their “AdBox” number and PIN number. By web portal, they can log on by entering the “AdBox” number and PIN number, and set preferences and retrieve, manage or respond to messages.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a screen print of an exemplary advertisement incorporating AdBox information in accordance with the present invention.

FIG. 2 is a diagram of the system architecture, which includes a conventional web-enabled server facility (center) with web-enabled communications and network configuration, including network security, to provide multiple web portals for users to access.

FIG. 3 is a screen print of the General Access Portal Home Page.

FIG. 4 is a screen print of the AdBox Order Form the advertiser would fill out if ordering directly from the ASP.

FIG. 5 is a screen print of the Authentication Form that a responder to an advertisement would have to correctly populate to send an AdBox Owner an email, rental application, resume, or payment for the item.

FIG. 6 is a screen print of the form a prospective purchaser would correctly populate to purchase the item the AdBox Owner is selling.

FIG. 7 is a screen print of the AdBox Owner purchase confirmation message.

FIG. 8 is a screen print of the rental application template provided by the ASP.

FIG. 9 is a flow diagram of the Reseller Portal.

FIG. 10 is a screen print of the Reseller Agent Create New AdBox purchase confirmation message.

FIG. 11 is a screen print of the Reseller Agent Create New AdBox Confirm form.

FIG. 12 is the Database Schema

FIG. 13 is a screen print of the Reseller ReUse AdBox Search form.

FIG. 14 is a screen print of the Reseller ReUse AdBox Search Result form FIG. 5 is a flow diagram of the AdBox Order Process for advertisers purchasing AdBoxes directly from the ASP.

FIG. 16 is a screen print of the AdBox Owner Notification Management tab.

FIG. 17 is a screen print of the AdBox Owner Templates & E-commerce options tab.

FIG. 18 is a screen print of the AdBox Owner “Inbox”. This particular screen print depicts the “inbox” of a recruiter that is hiring for 4 positions. The active inbox defaults to the ‘Account Rep’ position.

FIG. 19 is a flow diagram of the system's email receipt process

FIG. 20 is a flow diagram of the prospective purchaser telephone inquiry process when dialing the toll-free number to reach an AdBox.

FIG. 21 is a flow diagram of the AdBox Owner dialing the local access telephone number to retrieve messages, and/or setup the message box.

FIG. 22 is a screen print of the Reseller Landing page that will be active on the reseller's agent's desktop subsequent to logging in.

FIG. 23 is a screen print of the Reseller Agent Login page.

FIG. 24 is a screen print of the Reseller Agent Change Password page.

FIG. 25 is a screen print of the Reseller Agent Change Password Confirmation page.

FIG. 26 is a screen print of the Account Management page for adbox owners.

### DETAILED DESCRIPTION OF THE PREFERRED EMBODIMENTS

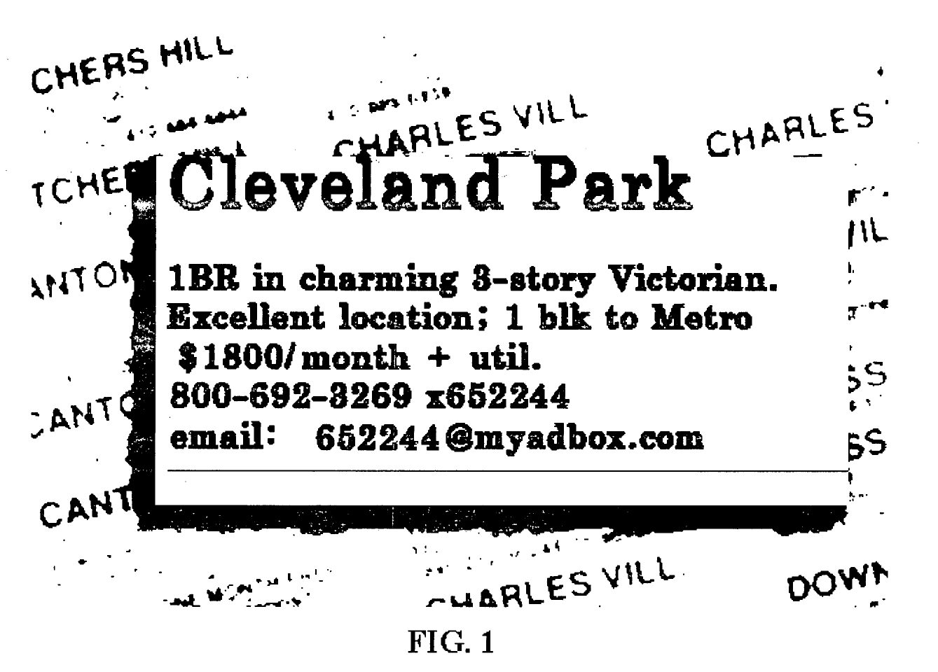

The present invention is an online voice & data messaging service that integrates all the tools needed for an advertising sales representative to resell to their customers, in real time, a blind “AdBox” including a temporary, anonymous toll-free phone number with attached Internet Voice & Data Messaging (IVDM) service for collecting ad responses, such that the phone number and email address for responses can be incorporated into the text of the advertisement as it is being bool(ed (a sample advertisement is shown in FIG. 1). The preferred architecture is a secure web-enabled server facility including multiple task-specific servers. The software is herein described in its preferred embodiment, which is adapted for distribution by an application, service provider (ASP) accessible by subscribers (the software being resident on the web server). One skilled in the art, however, will readily understand that the software method of the present invention can alternatively be distributed as shrink-wrap software or client-server software.

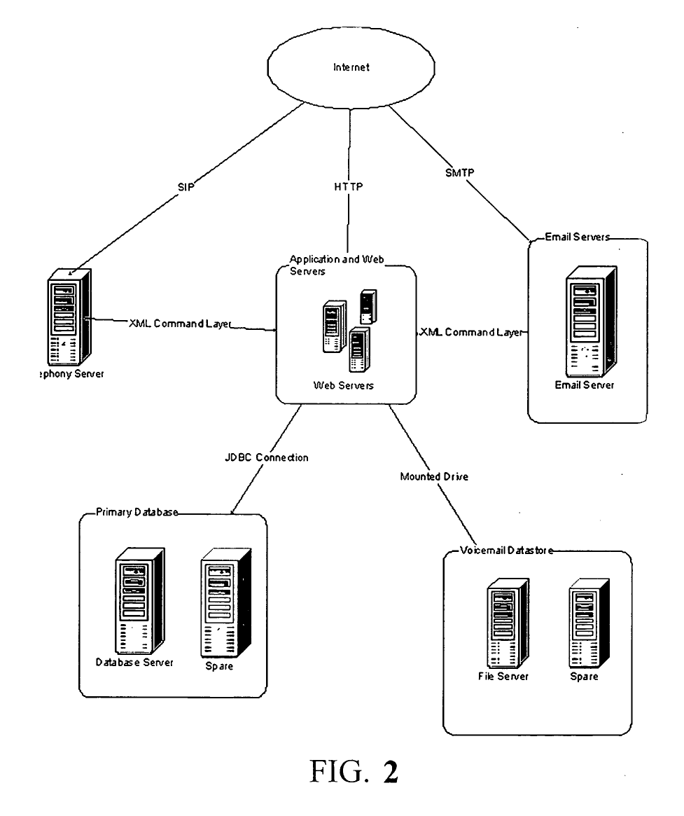

FIG. 2 is a diagram of the system architecture, which includes a conventional web-enabled server facility (shown at center) with web-enabled communications and network configuration, including network security, to provide multiple web portals for users to access. Secure client communications are accomplished via priority security technology, such as Cisco, and include a VPN, firewalls and encryption. Separate task-specific server banks are maintained for various services, including a telephony server, database server, voicemail server, file server, and email server.

Users interface with the web portal via their own Web browser. All users start their session by initiating their web-browser software, connecting to the Internet and the appropriate URL to access the resident software according to the invention. Minimum user requirements are a standard PC computer with a Pentium® or equivalent processor and 128 MB RAM, Windows® operating system, Internet Explorer® 4.0, and a dial-up or broadband connection. Each type of user accesses a different URL as described below.

### Method Overview

Users of the present system include the general public (including potential subscribers), AdBox Owners, AdBox Resellers, and Purchasers of the advertised goods or services. AdBox Owners are those who have purchased advertising from a media company in order to sell goods or services, and who now have purchased the AdBox service according to the present invention. AdBox Resellers are the advertising media companies themselves (such as newspaper, radio, TV and their agent sales representatives), who can profit from sales of AdBox services as well as increasing sales of advertising space.

In accordance with the present method, Resellers offer the service to their advertisers when they call or go online to place classified ads. Accepting the service will allow the AdBox Owner to place a toll-free number, 888-MyAdBox-xxxx (the xxxx signifying an assigned box number) and a private email address (xxxx@myadbox.com) as their contact information, rather than putting their own personal information in their ad (see FIG. 1). Resellers (classified sales reps or otherwise) can order AdBox services on their client's behalf through a dedicated Reseller web portal. Each AdBox is assigned an AdBox PIN number (which defaults to the last 4-digits of the subscribers phone number) upon completion of setup. A separate Product PIN is also generated which is used only if the AdBox Owner desires to receive a rental application, resume, or payment from a prospective tenant/employee/purchaser. The Reseller (sales representative) receives confirmation of the AdBox sale, in real time, and proceeds to communicate the AdBox PIN number, AdBox number, local access number and ASP's URL to the new AdBox Owner for their continuing use and management.

Thereafter, the AdBox Owner can access the message center to set up the box either through a second web portal, or by dialing the local access phone number and entering the AdBox number and AdBox PIN number. Setting up the box generally entails setting certain preferences and creating an outgoing voice presentation of the product they are advertising. The AdBox Owner (box owner) may also provide banking information along with the sale price of the item if they want to accept payment for their product through the My Ad Box secure payment system.

When the box setup is complete, the AdBox Owner has a complete transactional messaging platform at their disposal and is ready to start receiving calls, emails, faxes, applications, and (optionally) payment for their product. AdBox Owners have the ability to view email, listen to voice mails, and print faxes by logging on to the MyAdBox web portal. AdBox Owners also have the ability to dial their local access phone number to listen to messages. Email messages can also be heard (utilizing an embedded text-to-speech engine) when dialing in from a telephone. The AdBox Owner can also respond directly to messages via email, telephone or voice over transmission

Should the AdBox Owner make an agreement to sell their product, they provide the Purchaser with the AdBox and product PIN (product PIN being separate from AdBox PIN) numbers. The Item Purchaser can then log on to the system home page and select purchase product. Once in the system, the Item Purchaser need only enter the box number and product PIN number to authenticate. Once authenticated the Item Purchaser is presented with a Product Purchase Form where they enter their personal information, purchase price, and their credit/debit card or checking account information. This information is confirmed, and the system proceeds to collect the funds from the buyer and direct deposit them to the AdBox Owner's checking account.

In a similar manner, AdBox Owners have the option of receiving various applications through the system, such as lease applications. The system provides standard rental application and resume templates on the web site. When the AdBox Owner decides to interview a Purchaser (here a prospective tenant), they simply give their AdBox number and product PIN number to the prospective tenant. The Purchaser can then log on to the home page, enter the AdBox number and product PIN number, access the rental application, enter their personal information into the form, and submit the application to the AdBox associated with that AdBox and product PIN number.

Finally, after the AdBox Owner has sold or rented their product, they can log in to their AdBox message center and designate item sold, which instantly disables all notifications, and generates an automated message to callers and email inquirers that the item is no longer available.

It can be seen that the dual portal system provides a value-added service for resellers, streamlines the entire classified advertising process for advertisers, and can be employed in other advertising/selling scenarios as well. Moreover, it eliminates all potential problems associated with broadcasting personal contact information in classified advertisements. The system is described in more detail below.

### Software Implementation of the Method

The software provides several different user interfaces or “portals” for each type of user, and several different screens per interface. All screens are created in HTML, and follow a standard format, with a consistent look and feel. The functionality of each portal is herein described in the context of a walk-through.

1. General Access Portal

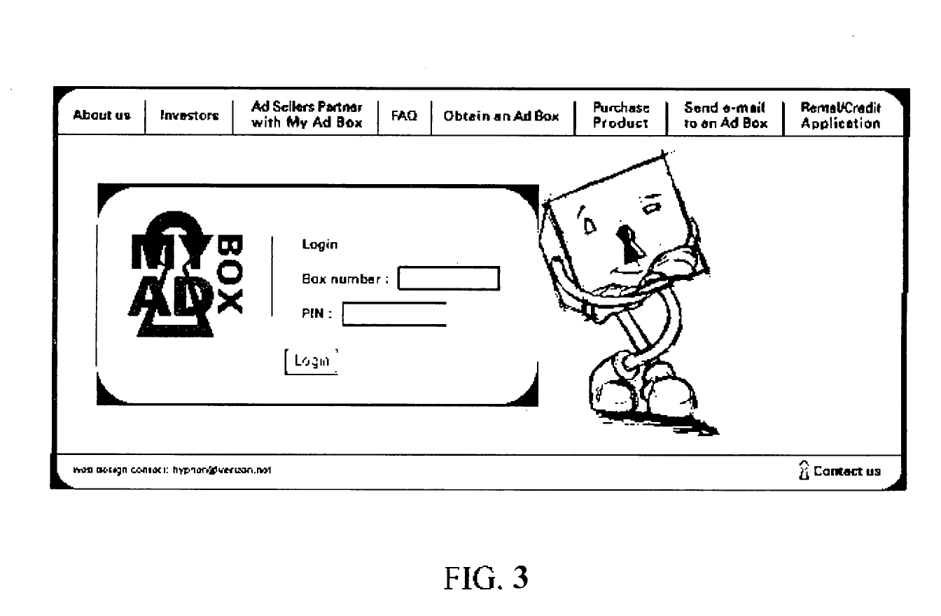

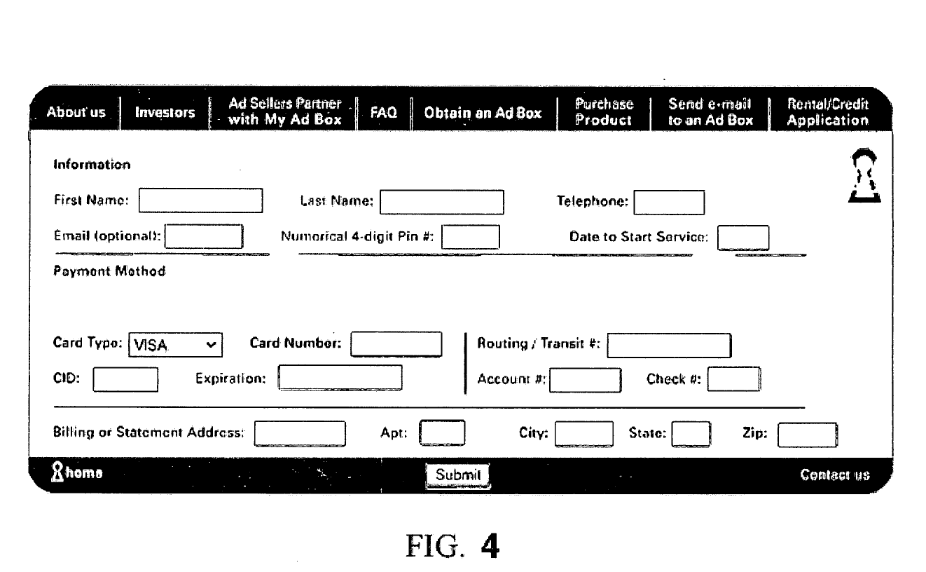

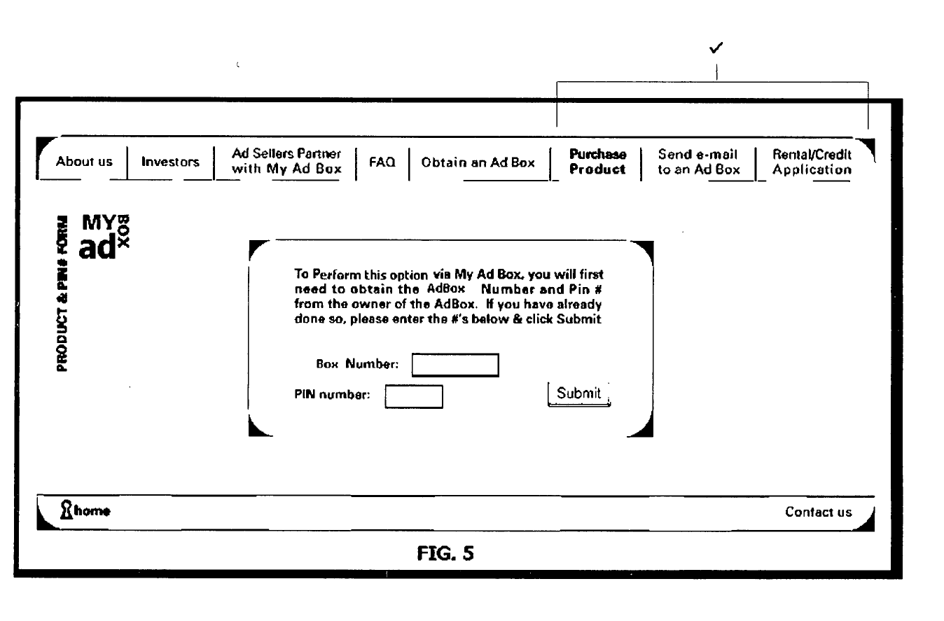

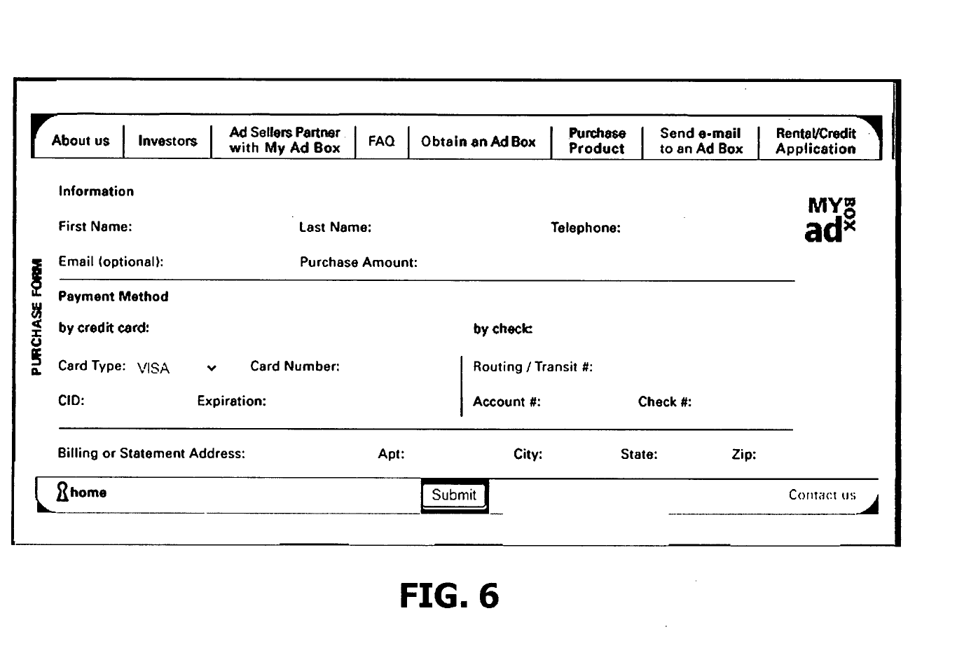

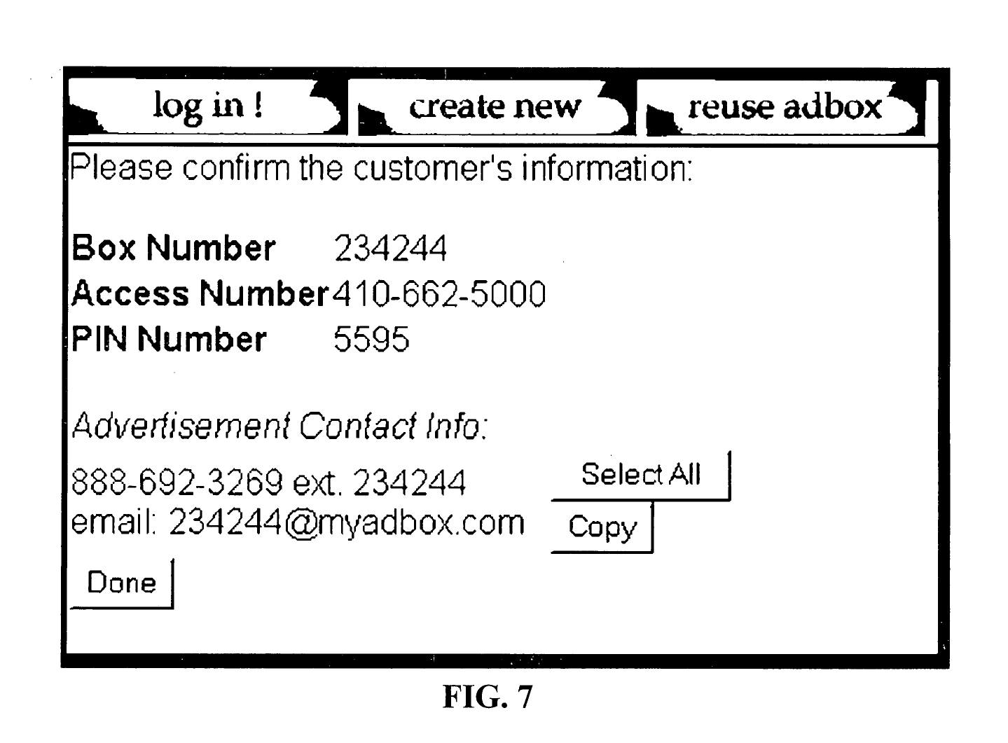

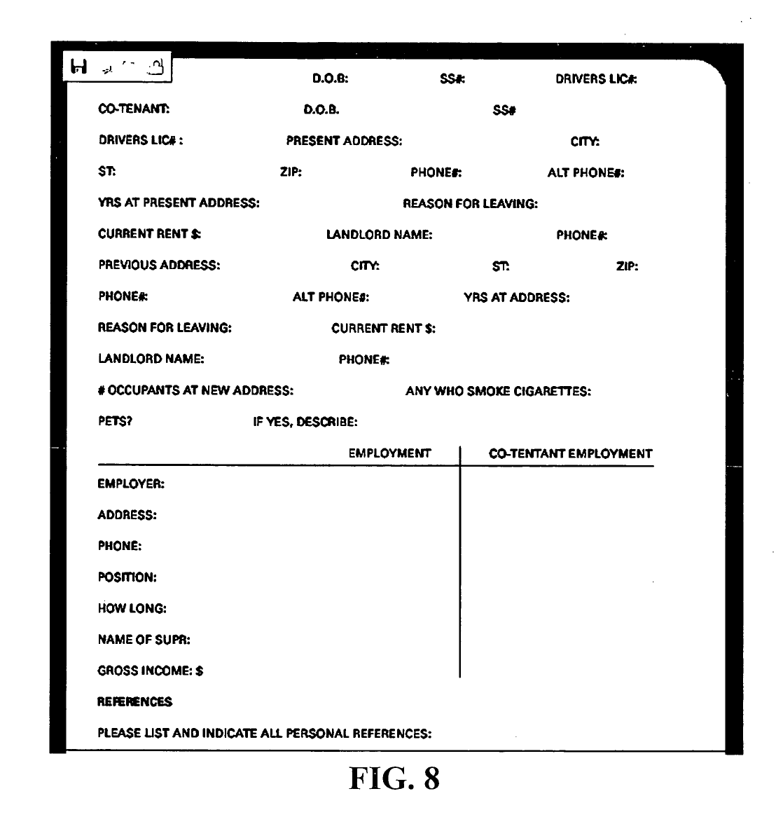

The open portal for the general public offers general information and serves as a gateway to the other portals, and generally includes the following menu of nested pages:
Home Page (FIG. 3)
About Us
   Who We Are (a company description)
   Product (a product description)
Investors (Secure Area with Information for Potential Corporate Investors)
How to Become a Reseller (Reseller Info)
   Partner Program (A description)
   Partner Info (A description
FAQ
Q & A
Purchase a Box
   Order Form (FIG. 4)
   Confirmation (FIG. 7)
Purchase a Product
   Authentication Form (FIG.5)
   Purchase Form (FIG. 6)
Send an Email to an AdBox
   Rental/Credit Application
   Authentication Form (FIG.5)
   Application Form (FIG. 8)
Contact Us
Privacy Notice

FIG. 3 is a screen print of the Public Home Page which is the first page that a user sees when going to the root URL (currently www.MyAdBox.com). The Home Page is the entry point for many of the users of the MyAdBox products/services. The Home Page Login provides a number of index-tab links (top) to various other nested pages, plus a login screen (center) for registered AdBox Owners.

For AdBox Owners to log in through the main portal, they must enter their AdBox number and AdBox PIN in the fields shown, then click the submit button. After authentication, the AdBox Owner is directed to their dedicated area. From there, they can access messages, manage their AdBoxes, and communicate with prospective purchasers as will be described.

The general public may, without logging in, take advantage of the other index-tab links (top) to various other nested pages. By clicking About Us>>Who We Are, an overview of the MyAdBox company is displayed. By clicking About Us>>Products & Services, a description of the services that MyAdBox.com offers is displayed. The Investors link leads to a secure area where investors in MyAdBox can find information.

By clicking Resellers Partner (Reseller)>>Partner Program, a web page is shown that describes how to become a MyAdBox.com partner (for example, a sponsoring media company that sells classified ads). By clicking Resellers Partner (Reseller)>>Partner Information, a form is provided for a potential reseller to submit information to MyAdBox.com.

The links to the Frequently Asked Questions (FAQ) and the Q & A (Question and Answer) pages provide helpful general information to users.

The Contact Us link displays all the relevant contact information for MyAdBox.com. Support numbers, email addresses, Reseller contact information, and the physical address of the MyAdBox.com headquarters.

Finally, a Privacy Statement link leads to a legal privacy statement for MyAdBox.com.

2. Reseller Portal

The software includes a separate portal or web interface that facilitates reselling of the service to advertisers via a channel of resellers, such as media companies with sales representatives that have a service agreement with the ASP. Each reseller registers and is given a unique reseller ID, and each agent of the reseller is given a unique ID within the reseller's organization. While logged on to their portal, the agents may offer the present AdBox service to their own advertisers. If an advertiser agrees to purchase the AdBox service, the reseller agent orders the service in real time (while still on the phone with the advertiser). All confirmation information (including AdBox number and AdBox PIN) is relayed back to the agent for communication to the new AdBox Owner. An AdBox confirmation message is shown in FIG. 7. Upon receipt of the information the AdBox Owner accesses their AdBox to set their preferences and outgoing presentation. This may be done over the telephone or via the web portal simply by entering the AdBox number and AdBox PIN, and setting preferences as described below. The new AdBox Owner may then retrieve, manage or respond to messages.

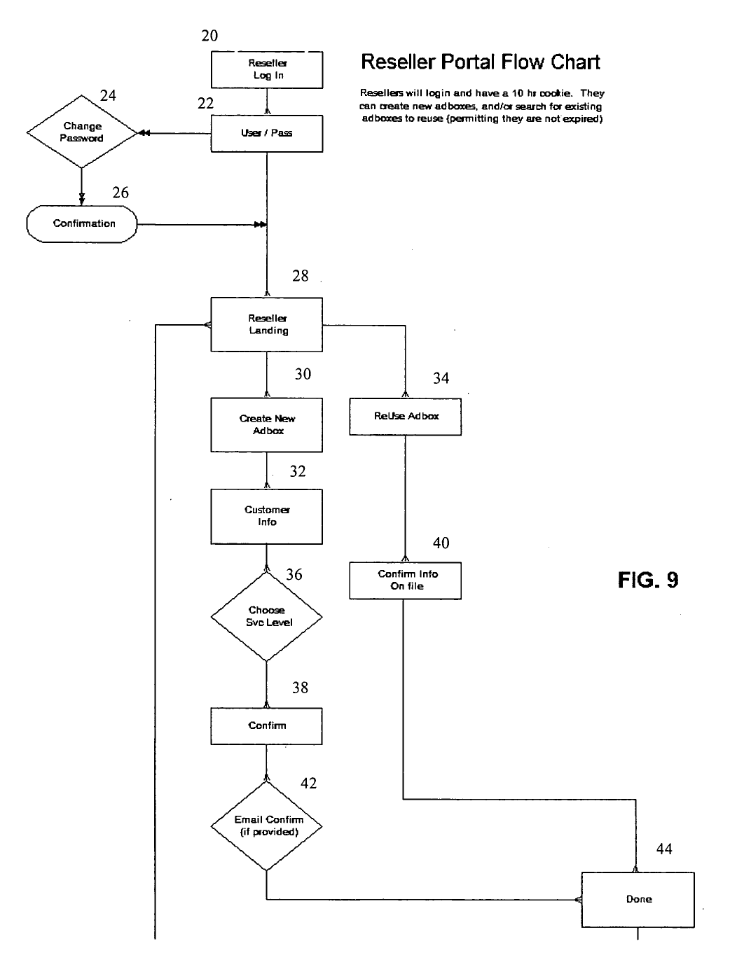

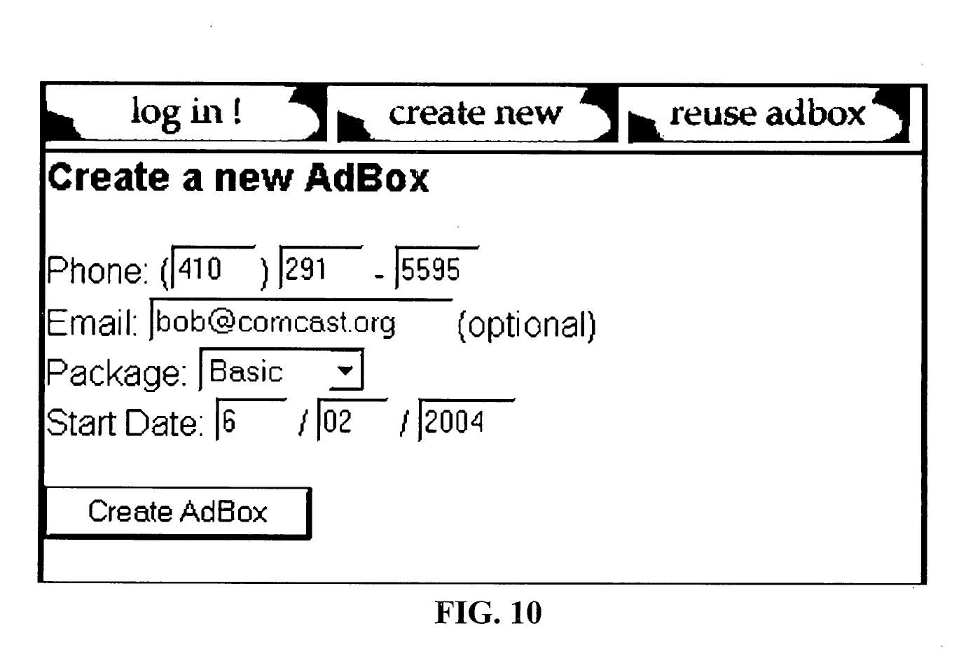

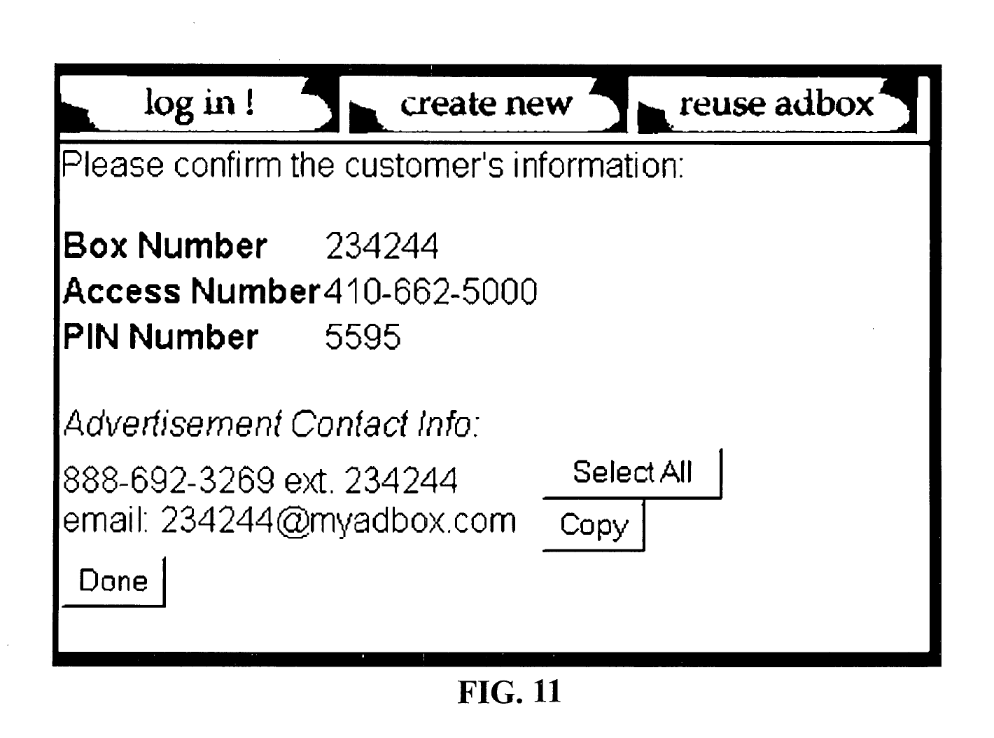

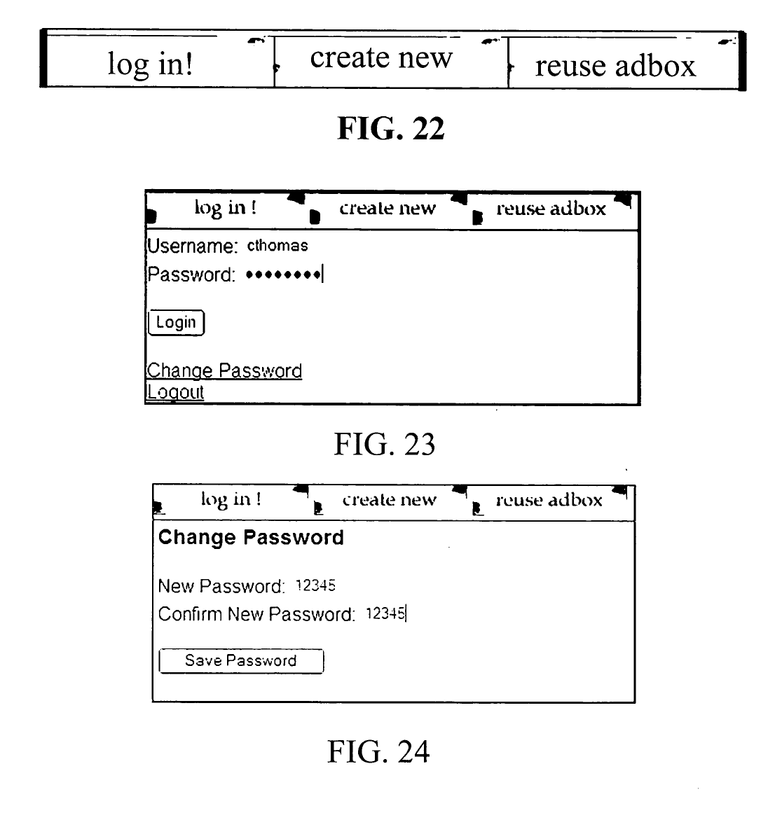

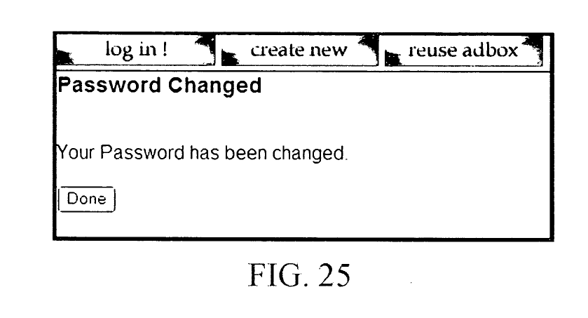

The Portal for resellers (advertising representatives) and its method of use is detailed in the flow diagram shown in FIG. 9 and herein explained with reference to the following nested pages:
Partner Login Page
   User Name (FIG. 22)
   Password (FIG. 23)
   Change Password (FIG. 24)
   Change Password Confirmation (FIG. 25)
   Logout
Create AdBox(es) (FIG. 10)
   Phone number
   Email Address
   Service Level
   Date to Start Service
   Confirmation (FIG. 11)
   Box#
   Local Access Phone Number
   PIN
   Advertisement Content (toll-free number, extension, email address)

As seen at step 20, authorized resellers of MyAdBox products are assigned a private URL and not a link off of the main MyAdBox web site (example: http://abccompany.myadbox.com). Their portal provides a simple web interface to create new AdBoxes for their clients. Initially, resellers are directed to a Partner (Reseller) Login Page with prompts for usemame and password. FIG. 23 is a screen print of the Reseller Agent Login page.

At step 22, Resellers log in to their respective accounts by entering a usemame and password. The reseller may alter their password if desired (steps 24, 26). FIG. 24 is a screen print of the Reseller Agent Change Password page. FIG. 25 is a screen print of the Reseller Agent Change Password Confirmation page.

If an advertiser has agreed to purchase the AdBox service the reseller agent will initiate the service in real time (while still on the phone with the advertiser). The reseller may choose whether to create a new AdBox at step 30 or to reuse one of their earlier AdBoxes by searching for an existing AdBox (step 34).

To enter a new account, at step 30 the Reseller is presented with a Create Mailbox(es) order form as shown in FIG. 10, which includes data fields for: Customer phone, email (optional), date to start service, and service package selected. This form is automatically populated with the advertiser's information via data mining, e.g., importing the information from the sales agents front-end ad order entry software to provide specific information needed to set up the new AdBox. This interface visibly collects contact information including: Phone number, email address, date to start service, and service level selected. The Reseller portal also invisibly collects: Customer name, address, and all available characteristics of the advertisement such as value-added products sold with the ad (attention banner, borders, bold print, color font, etc), linage (size in advertising inches), number of days the ad runs & dates, as well as other relevant data. For example, an autotrader.com classified may include Make, Model, Zip Code, Color, doors, engine size, drive train, transmission, milage, fuel type, body style, and VIN #. This info can be imported because it is already parsed in autotrader.com's system. The ad characteristics are stored as meta data in the main database and are linked to the subscriber's Adbox. The ad characteristics also include the dates the ad was published, up-sells accompanying the ad such as bold font, attention banners, borders, color font and any other distinguishable “feature”, the size of the ad (ad space is sold on a per advertising inch basis), and pricing (since pricing is automatically calculated in the front-end ad order entry system which makes it possible to import into the database). The extraction of specific data (including ad characteristics) from the Reseller's front-end AdBox order entry system allows for the tracking of responses and calculation of statistical data for the purpose of increasing ad copy effectiveness. in addition, once the foregoing data is imported as meta data, the System tracks the number of responses the subscriber box received. This allows ad-hoc reports to be generated based on a specific characteristic. For example: A report can list all of AutoTraders Chevy Blazer ads that had the engine size in the ad copy and another report of the same vehicle that did not have engine size in the ad copy. From there it is possible to analyze which listing drew more responses. By importing every possible ad characteristic from the Reseller front end and tracking responses to the AdBoxes it becomes possible to evaluate which details generate more responses.

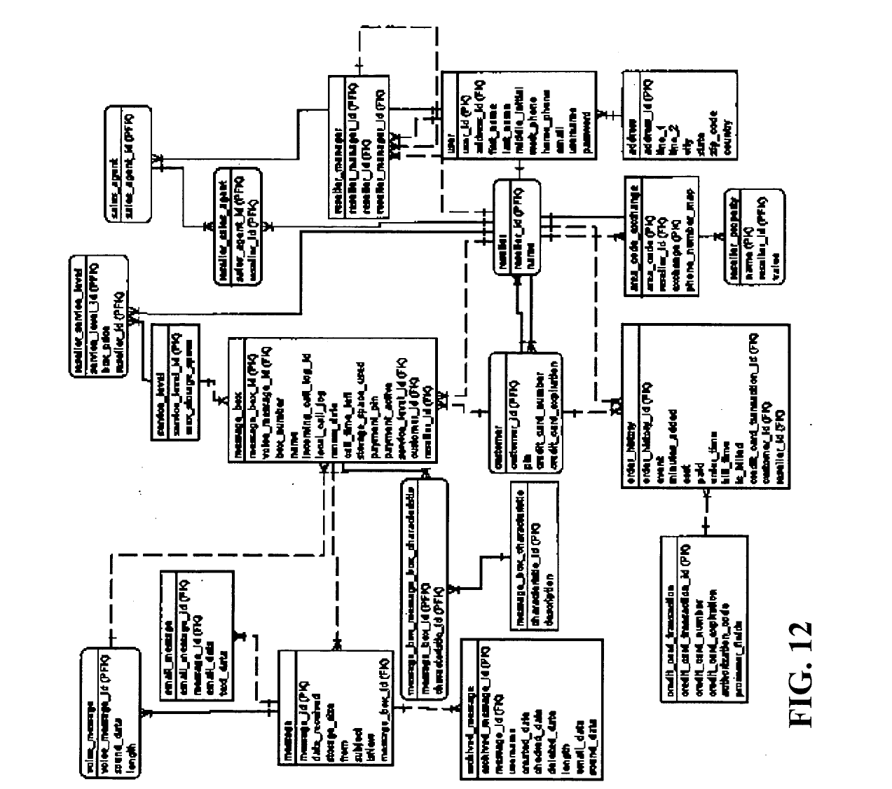

The agent is free to edit the visible form data. When the form is complete as step 32, the agent submits the form. As described more fully below, the present software evaluates the elements of the form and, if complete, the data is sent to the ASP's database (described below with reference to FIG. 12) and is stored as meta data referencing the AdBox, so as to facilitate analysis of the effectiveness of the characteristics as it relates to their ability to generate responses from potential consumers.

The method proceeds to step 36, where the Reseller may choose the service level the advertiser desires from among two total service levels (Basic and Premium). Premium service differs from basic service only in so much that it allows fax and call-forwarding capabilities.

After the system is able to confirm payment for the box, the server assigns a message box number, a local access phone number (based on the area code+local exchange evaluated from the reseller order form) for the AdBox Owner to retrieve messages. At step 38 a Box Sale Confirmation is provided and the information is relayed back to the agent for communication to the AdBox Owner. FIG. 11 is a sample confirmation page. The Reseller's confirmation states the Ad customer's AdBox number, PIN number (last 4-digits of customer phone number), and local access phone number. The toll-free number, AdBox number, and email address (box#@myadbox.com) are provided as text that can be copied and pasted into the Resellers existing front-end ad order entry software to eliminate transposing errors. In addition, the system will generate an email to the new AdBox Owner that contains all of the relevant information regarding the use of the box (providing an email address is rendered in the reseller order form). This includes instructions for configuration, the local access number, the email address to be used, and the expiration date.

Upon receipt of the information, the AdBox Owner accesses their AdBox to set their preferences and outgoing presentation. This may be done via telephone by dialing the local access phone number, and entering the AdBox number and AdBox PIN (default PIN will be the last 4-digits of the telephone number evaluated from the reseller order form) number. Alternatively, this may be done via the web portal. They can log on by visiting the homepage, enter the AdBox number and AdBox PIN number, and then they can set preferences and retrieve, manage or respond to messages.

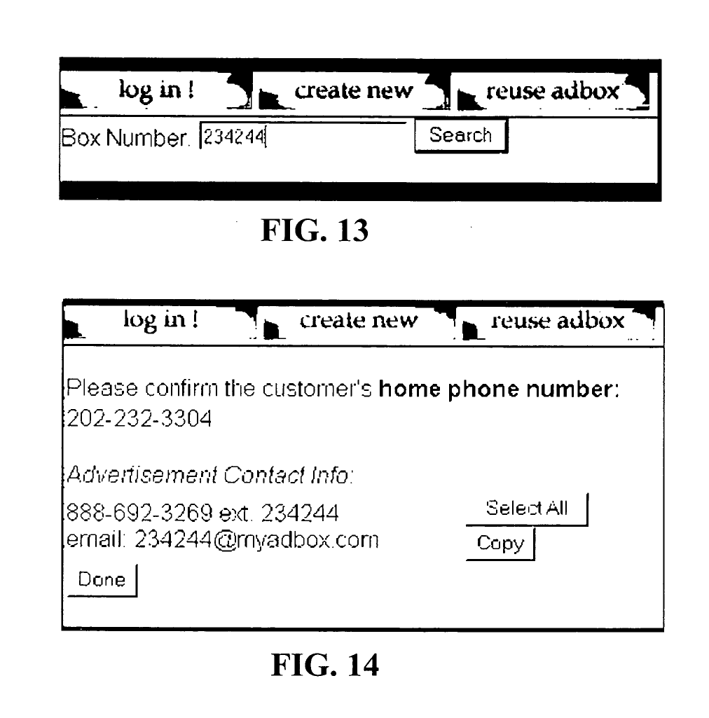

If the Reseller chooses to reuse an existing AdBox (step 34), they are given the option to search for an existing AdBox by AdBox number. The AdBox search form is provided in FIG. 13. The agent will enter the AdBox number given to them by the AdBox Owner and click search. The search results form is provided in FIG. 14, at which time the agent will confirm the phone number on the account with the AdBox Owner. Again, when confirmed the agent can copy and paste the advertisement content into their front-end ad order entry software.

It is noteworthy that the creation of the AdBox PIN via the Reseller portal and entry thereof into the database (resident on the database server of FIG. 2) must be synchronized with the file server. A PIN created or reset on the portal needs to be reflected within the file server in real-time. This is because voice*.wav files are stored separately from the information database, but need to be correlated to the AdBox.

### AdBox Owners

The General Home page provides an analogous method for AdBox Owners to purchase their own AdBoxes (without Reseller involvement) which is detailed in the flow diagram shown in FIG. 15. Once the portal is accessed as seen at step 50, the AdBox Owner may choose to purchase a new account at step 52.

At step 54 the user clicks Obtain an AdBox>>Order Form, which calls up the Create Mailbox(es) order form of FIG. 4 for individual users to purchase an AdBox. The Create Mailbox(es) order form of FIG. 4 includes data fields for: Customer name, phone, email (optional), desired 4-digitPIN, date to start service.

At step 55, the AdBox Owner chooses the Service Level from among two total service levels (basic and premium).

At step 56, the AdBox Owner enters payment information. After filling out the foregoing information the AdBox purchase is completed when the user clicks on Submit.

At step 57 a Box Sale Confirmation is provided. When the order form is completed and transmitted, the AdBox Owner receives an email confirmation at step 37 stating the Ad customer's box number, email address, and local access phone number. FIG. 7 is a representative confirmation page. The toll-free number, box number, and email address (box#@myadbox.com) are provided as text that can be copied and pasted into the ad to eliminate transposing errors.

Upon receipt of the information the AdBox Owner accesses their AdBox to set their preferences and to record an outgoing presentation. This may be done via telephone by dialing the local access phone number, and entering the AdBox number and AdBox PIN (default PIN will be the last 4-digits of the telephone number evaluated from the reseller order form) number. Alternatively, this may be done via the web portal of FIG. 3. They can log on by visiting the homepage, by entering the AdBox number and AdBox PIN number, and then clicking the appropriate tab to set preferences and retrieve, manage or respond to messages. Every time an AdBox is purchased the owner must (and is instructed to) set certain preferences allowing the AdBox Owner to enable and/or disable certain box preferences. These preferences are as follows . . .

A. Notifications

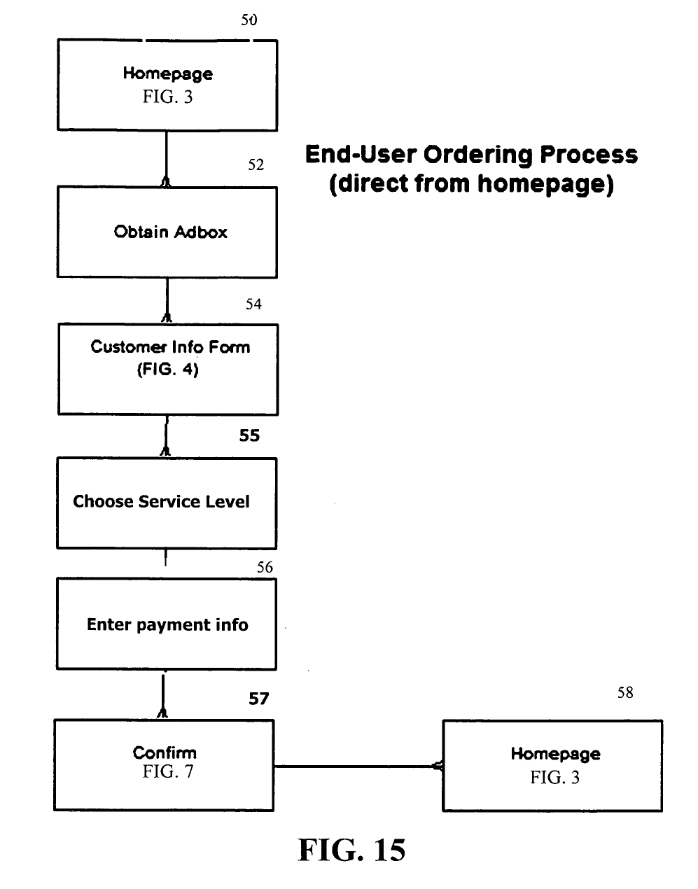

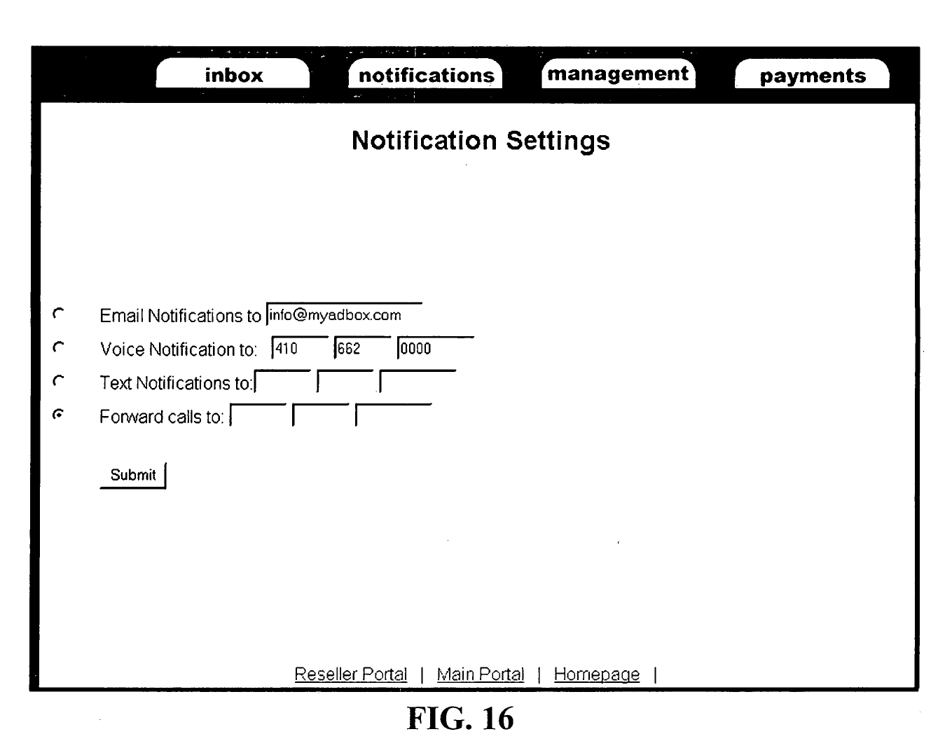

There are three options for the AdBox Owner to receive notifications of new messages in their message box. They can choose to have one method of notification. In their message box setup they specify if they want an automated telephone message, a text page, or an automated email for notification of new messages. The AdBox Owner then provides a phone number, a pager number, and/or an email address to which these notifications are sent. FIG. 16 is a screen print of the AdBox Owner Notification Management screen which displays how notifications can be enabled/disabled, as well as editing notification locations. A notification is sent once daily if new messages are present.

The AdBox Owner can also elect to have all calls to their box forwarded to a specified telephone number (only available with premium service level). If chosen, the AdBox Owner populates the form and specifies the number to forward the calls to. AdBox Owners can update/change the number to which their calls are forwarded at anytime. Notification options can be edited and/or enabled/disabled via the portal/screen as shown in FIG. 16.

B. Payment Option

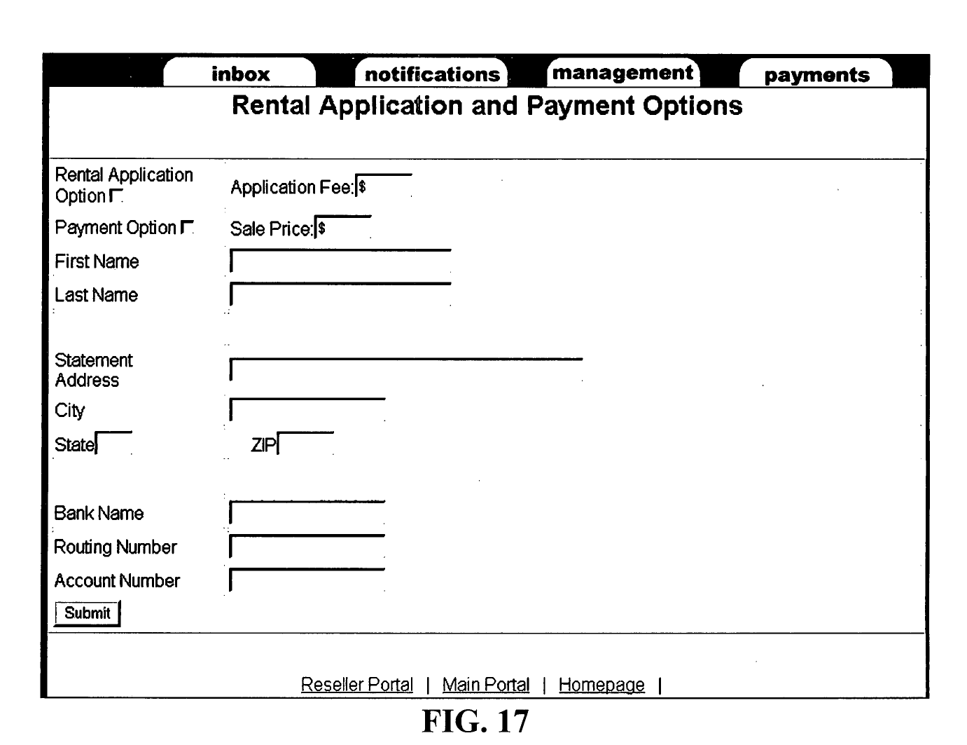

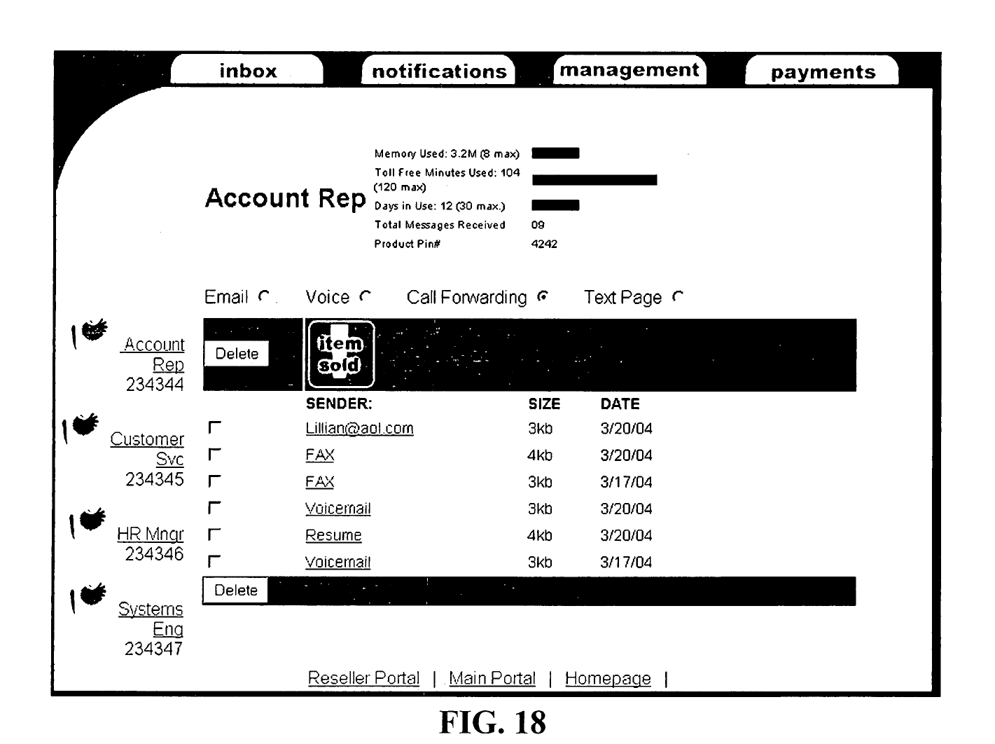

The AdBox Owner can choose to receive payment for their product through an integrated merchant account (currently limited to sale prices up to $500), or through a third-party escrow account (for sales over $500). If this option is elected, the AdBox Owner enables the payment option (as shown in FIG. 17) and enters their checking account information, and the price of the product. Once they have found a buyer for their product, they inform the buyer of the product PIN number (a random generated number located in the inbox statistics toolbar as shown in FIG. 18) for their item, and sale price. The buyer will then log on to the homepage and click purchase product. The buyer will be prompted for the AdBox number and product PIN number (given to them by the AdBox Owner) as shown in FIG. 5. When authenticated, the buyer is presented with and will populate the purchase form (FIG. 6) with their checking or credit/debit card information, purchase price, and personal information. Once the system verifies the information input from buyer and seller, it drafts funds from the buyer's checking account or perfonns a merchant charge to the credit/debit card for the amount of the purchase and applicable fees. Once the funds are received, they are direct deposited to the AdBox Owner's checking account.

As described, the system provides a similar ability for AdBox Owners to solicit rental/credit applications and resumes online. A potential lessee or employee can populate a pre-existing template of a credit/rental application (FIG. 8) or resume with their personal information. This requires the same authentication process as purchasing a product (FIG. 5). Clicking submit will send the document to the message box of the specified AdBox and product PIN number as an Adobe® PDF file or similar file type.

C. Outgoing Presentation

While setting up preferences, each AdBox Owner must record an outgoing presentation for their product. This message will be heard by every caller who dials the toll-free number and enters their AdBox number. The AdBox Owner is allotted 60 seconds to describe their product in detail, and give all pertinent information to their potential buyers. This message can be re-recorded at anytime by the AdBox Owner.

D. Sale Complete

FIG. 18 is a screen print of the AdBox Owner Check Messages interface, which contains the text messages sent to the active AdBox. The AdBox Owner can set the AdBox to sold (by the “item sold” button shown in FIG. 18) so that customers will receive an auto-message stating item is no longer available. Setting the box to Item Sold disables the notifications, payments, and rental application features.

### Prospective Purchasers

Prospective Purchasers will have the AdBox Owner's toll-free number 888-MyAdBox and assigned box number, plus a private email address (boxnumber@myadbox.com) from the contact information left in the ad (as seen in FIG. 1). Thus, Prospective Purchasers can leave inquires by phone or by email. For example, prospective purchasers may send an Email to an AdBox by clicking the appropriate link from the general homepage, which engenders a conventional Email Submission form to send an email to a given AdBox. Email message inquiries are sent directly to the AdBox.

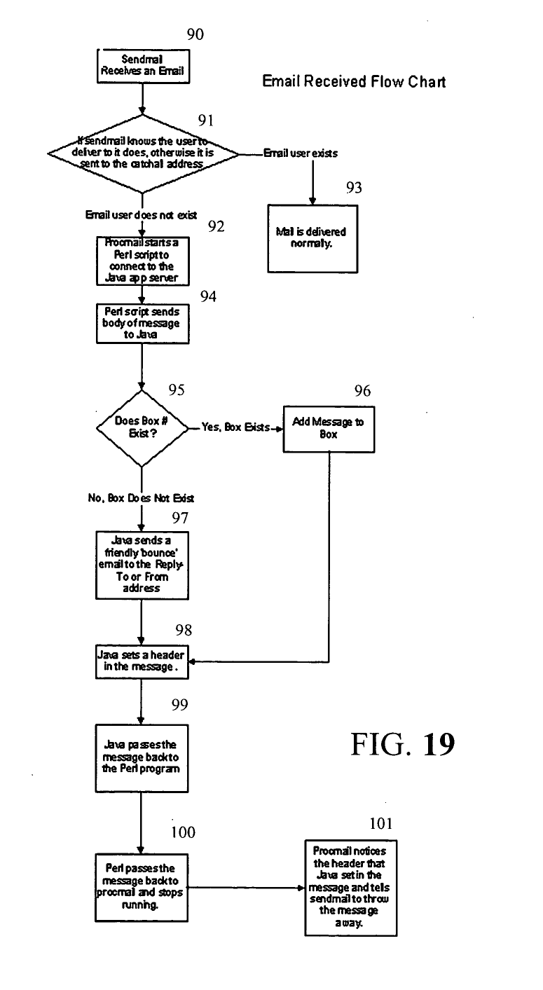

FIG. 19 is a flow diagram of the email registration process. At step 90, the AdBox server receives an Email and, at step 91, checks it against the database of existing AdBoxes. If the recipient is known, the email is delivered normally as at step 93. If not known, the email is sent to a catch-all address. At step 92, the system starts a Perl script to inspect the body of the message, and if, at step 94, it finds an existing box number in the body of the email it is sent there at step 95. If, at step 97, there is no box number then the server sends a bounce notification to the sender, and the message is deleted at step 101.

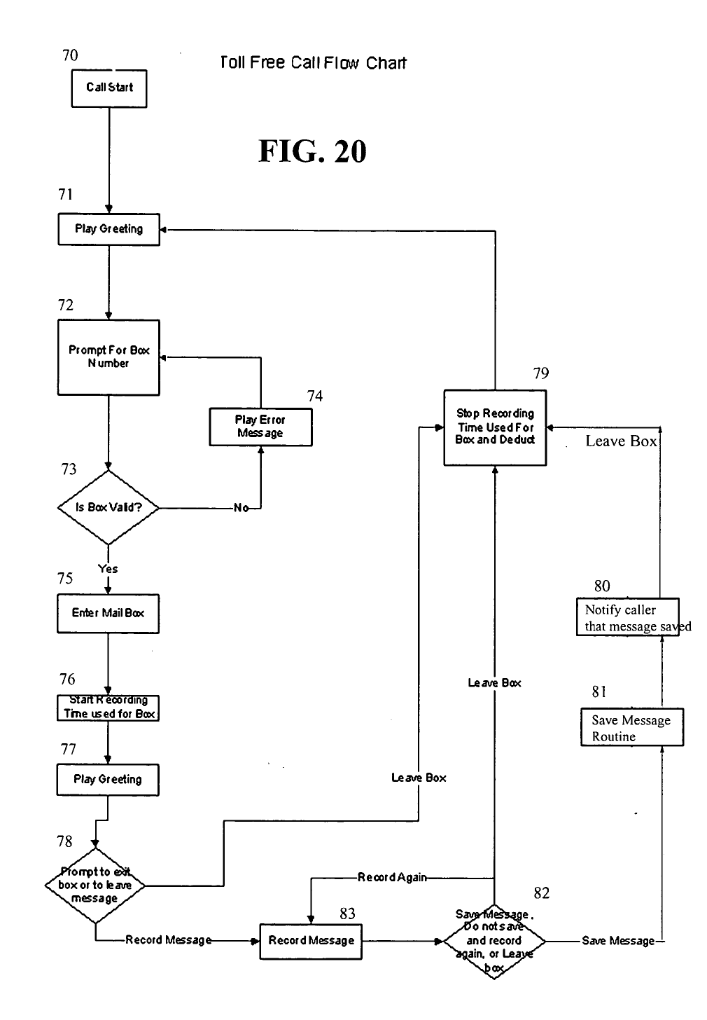

FIG. 20 is a flow diagram illustrating the messaging method if the Prospective Purchaser inquires by phone. At step 70, the Prospective Purchaser makes a toll-free call and, at step 71, receives the greeting. At step 72, the greeting leads into a prompt for the AdBox Owner's box number. The software checks the box number against the database to determine if it exists, and if not speaks an error message at step 74. If the box number is valid, flow proceeds to step 75 and the Prospective Purchaser enters the mail box. At step 77, the AdBox Owner's greeting is played (usually identifying) the item being sold and, at step 78, the Prospective Purchaser is prompted to leave a message. The message is recorded at step 83, and at steps 80-82 the Purchaser is given standard voice mail options to save, discard, re-record, etc.

When the AdBox Owner makes an agreement to sell their product, they provide the AdBox number and a product PIN number to the Purchaser. The Purchaser may then log on to the system home page and select Purchase a Product>>Purchase Form. They are then prompted for box number and product PIN number as shown in FIG. 5. They may then purchase and pay for the item (FIG. 6) online via the MyAdBox.com merchant account and payment system.

When the AdBox Owner is leasing or renting something and has a prospective lessee, they provide the AdBox number and product PIN number to the prospective lessee. The prospective lessee may then log onto the system home page and select “Rental Credit Application” (FIG. 5), and proceed to complete the respective application.

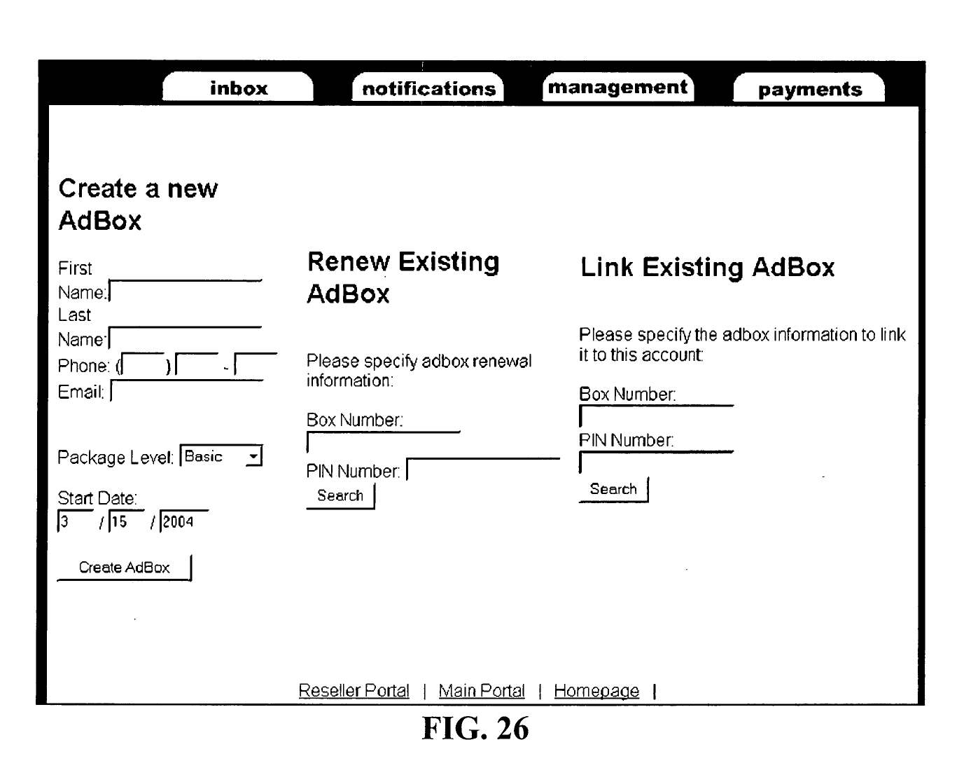

If the AdBox Owner chooses to maintain an existing account, they must log in at the home page of FIG. 3 and are then given the various options outlined above to maintain their AdBoxes, including renew boxes, create new boxes, or link boxes not currently associated with the account (as shown in FIG. 26).

### Retrieving AdBox Messages

AdBox Owners may check all their messages via the AdBox Owner web portal, or by phone. By web, the AdBox Owner Check Messages interface is extremely intuitive and largely mimics the visual cues of Microsoft Outlook®. FIG. 18 is a screen print of the AdBox Owner Check Messages interface, which contains both text messages sent to the active AdBox as well as voicemail messages that have been converted to .wav files. The Inbox environment features an explorer bar to the left displaying folders for each AdBox that the AdBox Owner has purchased. To view the messages for an AdBox the owner will click on the folder of the AdBox in the explorer bar. This triggers a perl script to populate the inbox environment with the messages, preferences, and inbox statistics toolbar of that particular AdBox. The AdBox numbers will be the default names of the folders in explorer bar. The folders can be re-named (as they have in FIG. 18) for greater clarity of contents. Each AdBox displays a box statistics toolbar (top) displaying remaining toll-free minutes, total disk space usage, total number of responses, total days (out of 30) used, and product PIN number. AdBox statistics that have limits appear in red when capacity has reached 80%. The inbox toolbar also lists all available box preferences such as notification types, payment and rental application option, and account management. These preferences are specific to the AdBox that is active in the inbox tab.

Once an AdBox Owner decides to listen to a voicemail audio file from the web portal (such as that from J. Smith), just by clicking on it the file will automatically open with the user's default .wav handler (the vast majority of users will have Windows Media Player “WMP” for this). There is skepticism as to how well WMP performs this function. As a backup, if the user's WMP is deemed unacceptable, a Java 1 based browser multimedia plug-in is available for download which is compatible with all Internet Explorer and Netscape browsers released within the last 3 years.

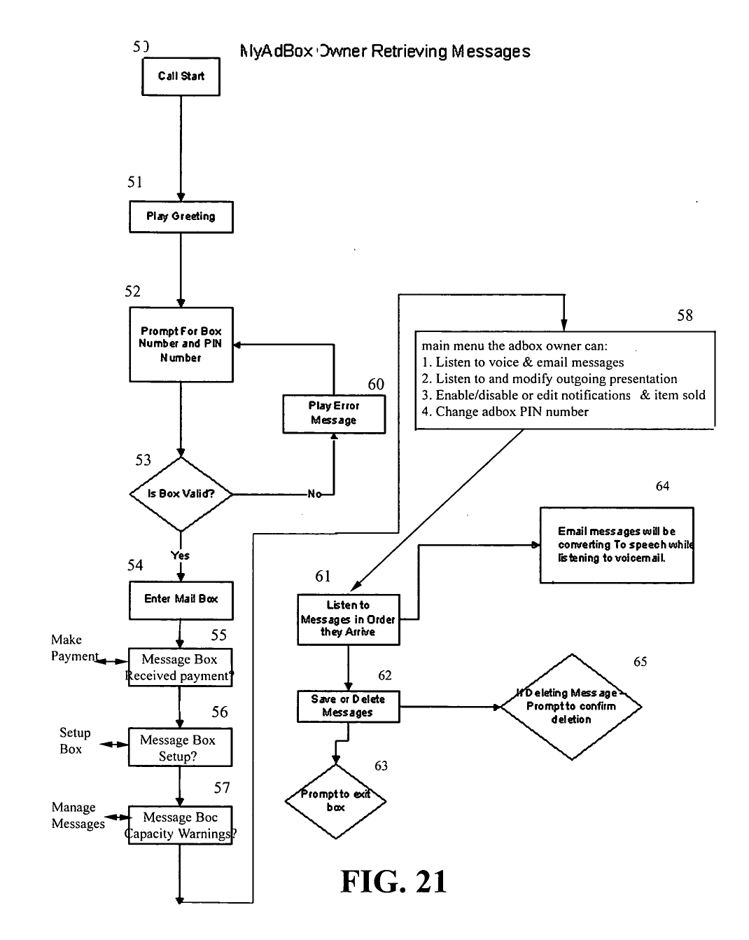

If, on the other hand, a MyAdBox Owner checks their messages by phone, the process is illustrated by the flow diagram in FIG. 21. At step 50, the MyAdBox Owner initiates a call to the local access phone number. When setting up the AdBox, each AdBox Owner is assigned a phone number that is in their local calling area . The local numbers are provided to the ASP by a broadband telephone company. The broadband phone company receives the calls from AdBox Owners into a SIP Gateway (Session Intiated Protocol). If the calls are originating from a PSTN (public switched telephone network) the broadband company will translate the analog signal into a digital signal and route the call over the intemet (process known as Voice over Internet Protocol) to the ASP. The ASP's SIP Gateway will then decode the digital signal back to an analog signal which will then be translated into binary code for easy transference between the telephony, application, and database servers. At step 51, a greeting is played and, at step 52, the MyAdBox Owner is prompted to enter their AdBox number and PIN number. The system checks this data, and if keyed incorrectly plays an error message at step 60. If the data is correct at step 53 the MyAdBox Owner enters his AdBox at step 54. At step 55, the system checks to see if the message box has received payment. If not the caller is routed through the payment process. If the message box has been paid then, at step 56, the system verifies if the message box has been setup. If the message box has NOT been setup, the AdBox Owner is guided through the setup process. If the message box has been setup then, at step 57, the system proceeds to check to see if there are any capacity warnings. If there are no warnings, the AdBox Owner reaches the main menu at step 58. From the main voicemail menu the AdBox Owner can:
1. Listen to voice & email messages
2. Listen to and modify outgoing presentation
3. Enable/disable or edit notifications, and enable/disable ‘item sold’ option
4. Change AdBox PIN number

If, as the diagram shows, the user chooses to listen to voice & email messages at step 61, the voice messages play first automatically in the order they arrived. In the meantime, at step 64, in anticipation of the user requesting the emails to be read as speech, the system will start converting all messages to temporary .wav files. This conversion process is conceptually represented as follows:
1. Email message is retrieved from the database from an Asterisk-requested JMS query
2. The message is stripped of all internet and HTML tags
3. The body of the email is passed to the AT&T runtime TTS engine
4. The output is stored as a temporary .wav file to be played after each of the regular voicemails has been played. 5. The temporary .wav file is deleted (There is no need to store this .wav file since it can be recreated at anytime so long as the email is stored).

Thus, after all voice mails have been heard the system is prepared to read the emails as speech, and proceeds. In all cases, at step 62, the user may save or delete the messages, and must confirm each deletion at step 63.

Box owners can own multiple boxes which are linked in the database. For owners that have purchased several active MyAdBoxes, all boxes are intuitively displayed on the left pane of the inbox portal screen (as shown in FIG. 18) to allow for the clear separation of messages and settings. When signed in to any one box, other linked boxes will appear as folders in the explorer bar. Linked AdBoxes shown in the explorer bar include the linked AdBox numbers. Thus, an AdBox Owner can switch between inboxes by clicking on the AdBox folder in the explorer bar.

An AdBox Owner can respond to emails directly and can Compose, Reply, Delete, Attach Files to composed messages, and Forward (with attachments).

### Database Schema

FIG. 12 is a printout of the relational database schema for the present system. All of the foregoing collected information is incorporated into tables in a structured relational database whereby storage tables are inter-related by one or more shared fields. Basic data is used to populate a relational database in which all of the tables are relationally-linked. Presently, MySQL is the preferred database server software. FIG. 12 shows the preferred relational links between fields in the above described tables, including field-to-field assignments between common fields in related tables. All table data is stored in memory pursuant to the above-described storage structure in relational database format and thereby supports meaningful queries.

It is also critically important to properly join voicemails (stored in file system) and email messages (stored in database) to the correct AdBox. This is accomplished by storing all email data as objects within the database and file system after the application server has applied the appropriate business logic to the data, making the relationship inherent. For example: a caller leaves a voicemail message for box number 12345, the system will register the binary file as an insert into the file system with a MyAdBoxID of 12345, which will be applied to the file by the applications server. Likewise, when a user sends an email to 12345@myadbox.com, this is translated to the database insert command for MyAdBoxID 12345 which will be applied by the application server as well. Then, when the user logs in to his account via the web portal the system runs a query to display all email messages in the database and voicemail messages from the file server for MyAdBoxID 12345. The primary format for voicemail audio storage is a binary file that will be a GSM-encoded .wav file for replay. These wav files are stored as binary objects directly in the file system.

All voicemail services and interactive voice responses, message queuing, and internet voice and data transports rely on Asterisk®, a complete PBX software solution resident on the voicemail server of FIG. 2. Asterisk® runs on Linux, does voice over IP in many protocols, and can intemperate with almost all standards-based telephony equipment using relatively inexpensive hardware. Asterisk® also has built-in support for the GSM .wav codec. The file size of a one minute message encoded at 8 Khz, single channel mono will be approximately 90 kilobytes. Therefore, each AdBox is allocated an 8 MB quota so that users will be able to store approximately 88 minutes of voicemail messages.

The database includes automatic maintenance utilities (timed processes) ensuring that storage is maximized by cleaning out boxes when they are not in use, and alerts the administrator in the event that manual system administrative functions need to be conducted.

It should now be apparent that the above-described ASP framework for Internet Voice & Data Messaging services (inclusive of the architecture and voice messaging solution with user interfaces) gives media companies such as newspapers a new capability to offer, and seamlessly resell to their advertisers, an anonymous “AdBox” at the same time as that ad space is being booked.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

1. A method for online voice & data messaging, comprising the steps of:
providing a first web portal including graphical user interface for a sales representative to sell a blind ad box voice messaging service to their advertising clients, in real time, as said clients place an advertisement, said first portal allowing said sales representative to purchase the ad box on the client's behalf, receive a blind ad box number and PIN number, as well as a blind telephone number and email address for inquiries, in order to convey said blind ad box number and PIN number to the client, whereby said client can place the blind telephone number and email address in said advertisement rather than personal information;
providing a second web portal including graphical user interface for said client to access and manage the blind ad box voice messaging service, to set preferences therefor, and to access inquiries from potential purchasers relating to said advertisement.

2. The method according to claim 1, wherein said second web portal and graphical user interface also allows potential purchasers to enter the blind ad box number and PIN number and then purchase a product or service from said client.

3. The method according to claim 2, further comprising the step of collecting payment information from said purchaser, collecting payment funds electronically, and transferring said payment funds to said client.

4. The method according to claim 2, further comprising the step of allowing the client to access the second web portal upon sale of said product or service and designate an item sold option, whereby all further notifications to said ad box are disabled and further inquiries receive an automated message that said product or service is no longer available.

5. The method according to claim 1, further comprising the step of providing a local phone number for access by said client for retrieving said messages by entering the ad box number and PIN number.

6. The method according to claim 2, further comprising the step of obtaining payment for said product through a merchant account and transferring said payment to said client.

7. The method according to claim 1, further comprising the step of providing an online rental application in response to inquiries from prospective lessees.

8. The method according to claim 1, further comprising the step of providing an online employment application in response to inquiries from prospective employees.

9. The method according to claim 1, wherein said client can access and manage multiple blind ad boxes through a single user interface.

10. A messaging system, comprising:
a secure web-enabled server facility with resident software accessible from an application service provider for online voice & data messaging services, said software further comprising,
a first graphical user interface adapted for agents of media companies to interact with potential consumers of their ad space and to sell a messaging ad box service to said consumers while on the phone so that said consumer can place a blind telephone number in said ad space, and
a second graphical user interface adapted for said consumers to manage messaging ad box service and to retrieve calls from potential buyers of their product.

11. The system of claim 10, wherein said second graphical user interface comprises a unified inbox providing access to multiple ad boxes from a single interface.

12. The system of claim 10, wherein said second user interface is accessed by entering an adbox number and adbox PIN.

13. The system of claim 10, wherein consumers log in through the first user interface by entering an AdBox number and AdBox PIN number.

14. The system of claim 10, wherein said first user interface allows agents of media companies to orders the adbox service in real time while still on the phone with the consumer.

15. A method comprising the steps of:
providing a first web portal including graphical user interface for a sales representative to sell a voice messaging service to advertising clients after the sales representative has booked an advertisement using their own simultaneously-running sales software;
providing a second web portal including graphical user interface for said clients to access and manage the voice messaging service, to access inquiries from potential purchasers relating to said advertisement;
compiling a database of data derived collectively from said first web portal and said second web portal.

16. The method of claim 15, wherein said step of compiling further comprises importing ad characteristics about the booked advertisement from the sales representative's simultaneously-running sales software into said database.

17. The method of claim 16, further comprising a step of tracking responses to the booked advertisement from the voice messaging service for the purpose of increasing ad copy effectiveness.

18. A messaging system, comprising a web-enabled server facility with resident software accessible from an application service provider by account subscribers for online voice & data messaging services, said software further comprising a single graphical user interface capable of managing the multiple ad box accounts of each subscriber and for retrieving messages from each of said accounts, thereby increasing the efficiency of managing messages for multiple voice message box subscribers.
